(19) United States
(12) Patent Application Publication
(10) Pub. No.: US 2014/0122122 A1
(43) Pub. Date: May 1, 2014

(54) METHOD OF MANAGING A CHRONIC DISEASE

(71) Applicants: Jeffrey Cooper, Bowie, MD (US); Mark Hahs, Bakersfield, CA (US)

(72) Inventors: Jeffrey Cooper, Bowie, MD (US); Mark Hahs, Bakersfield, CA (US)

(21) Appl. No.: 13/891,553

(22) Filed: May 10, 2013

Related U.S. Application Data
(60) Provisional application No. 61/688,226, filed on May 10, 2012.

(51) Int. Cl. G06Q 50/24; G06Q 10/00

(52) U.S. Cl. CPC G06Q 50/24; G06Q 10/00
USPC 705/3

(57) ABSTRACT

A method of managing a chronic disease suffered by a patient. The method includes the steps of determining a management plan for the chronic disease, using a real time analysis module for analyzing and modifying the management plan in accordance with environmental factors, determining a regiment of medications for managing the chronic disease in accordance with the management plan and generating a plurality of reminders for the patient to take the regiment of medications.

### CROSS-REFERENCE TO RELATED APPLICATION

The present application claims priority to Provisional Application Ser. No. 61/688,226 entitled “Method of Managing A Chronic Disease” filed on May 10, 2012 and is incorporated herein by reference.

### TECHNICAL FIELD

The present invention generally relates to the medical field and more particularly, is directed to a method of managing a chronic disease using a software application.

### BACKGROUND OF THE INVENTION

The number of people who suffer from chronic diseases continues to rise on a yearly basis. Many of these diseases require constant treatment and lifestyle changes that for many is difficult to maintain.

The present invention provides a software application that will aid and assist a person suffering a chronic disease to treat and manage the disease.

The novel features of the present invention are set out with particularity in the following detailed description of the preferred embodiment. However, the invention will be understood more fully and clearly from the detailed description of the invention as set forth in the accompanying drawings in which:

### BRIEF DESCRIPTION OF THE DRAWING

FIG. 1 is a block diagram illustrating the various components of a smart phone on which the present invention may be practiced.

### BRIEF DESCRIPTION OF THE PREFERRED EMBODIMENT

A brief description of one embodiment of the present invention will be described in relation to a software application for asthma suffers. The invention, however, is not limited to asthma.

The present invention is implemented on a smart phone, or other similar device. The invention provides medication adherence, weather conditions, peak flow readings, an asthma action plan, personal health records connectivity with an electronic medical record, emergency alert notification and an Asthma diary.

The system of the present invention provides the following function:

### 1. Overall

a. Can be used on an iPhone, iPod, iPad or similar device
b. An Asthma Action Plan
   i. The system will require an online form for the health practitioner to enter the plan for the patient prior to the system being activated for the patients use.
   ii. The system will require a Patient ID and Patient Name.
c. The system allows mobile device configuration for Parental Controls to limit inappropriate content and use of the phone or system.
d. The system automated polled for local weather and environmental conditions while the system is operating on the patient's device.
e. The system provides push notifications for medications, diary entry reminders and an escalation tree.
   i. Reminder escalations can be based on
      1. Medications
      2. Symptoms
      3. Plan
   ii. Reminders will include what to do for:
      1. Late
      2. Skipped
      3. Symptom Triage
   iii. Automatic Timed-Push Notification based on medication prescription inputs
   iv. After 24 Hours SMS
   v. After 72 Hours Call
      1. Dr. Office
      2. Case Manager
      3. Nurse
      4. Insurance Provider
f. GPS “Use My Location” for Weather Lookup and Geo Tagging Data Records
g. All events, notifications and actions by the system and/or user will be recorded for analytics and purposes.
   2. The system will allow language (localization) preference

a. Select Your Language

b. English

c. Spanish

3. For a first time user, the system will gather patient profile information, such as:
a. First Name
b. Last Name
c. Gender
   i. Male
   ii. Female
d. Date of Birth
   i. Day
   ii. Month
   iii. Year
e. Height
f. Weight
g. Race and Ethnicity
h. Health History or PHR tie-in as specified in study
i. The system will provide a review of the Asthma action plan as follows:
   i. Select Medication(s)
      1. Asthma Medication (Database)
         a. Brand Name
         b. Medical Name
         c. Thumbnail Photo
         d. Dosage
         i. One Puff
         ii. Two Puffs
         iii. 4 Puffs
         iv. One Vial
         v. One Inhalation
         e. Frequency
         i. Every 4 hours
         ii. Every 6 hours
         iii. Every 8 hours
         iv. Every 12 hours
         v. Every 24 hours
         f. Number of doses in each refill—auto decrement
         g. Pharmacy
         h. Other Meds
j. Health History PHR
   i. Enter/Review Required Elements
   ii. Enter/Review Optional Elements

The following steps illustrate a typical patient's use of the present invention:

### 1. Login

k. Username
l. Password
m. Remember Me
n. Forgot Password
o. Help

### 2. Main Screen/Mobile Dashboard

p. Air Quality Condition
q. Scoreboard
r. Leaderboard
s. Rewards
t. Badges
u. Reminders

### 3. Required Patient Compliance Work-flow (Asthma Personal Daily Record-APDR)

v. Check Air Quality Reading
   i. Tap Button/Check Box for Acknowledgement
w. Take Medication
   i. Take Photo of Yourself Using Inhaler
   ii. Tap Button/Check Box for Acknowledgement/Adherence
   iii. Decrement metered dose and/or doses in prescription to refill
   iv. Phase II: Acquire data from Compatible Bluetooth Inhaler
x. Perform Peak Flow Meter Reading
   i. Record 3 digit Values from Peak Flow Meter Device into App
   ii. App Calculates and Displays preliminary “Action Plan Zone”
   iii. Tap Button/Check Box for Acknowledgement/Adherence
   iv. Date/Time Stamp
   v. Phase II: Acquire data from Compatible Bluetooth Peak Flow Meter
y. Asthma Journal Entry—How Am I Feeling. Must comply with study in terms of symptom tracking and scales.
   i. Tap on Appropriate Symptoms
      1. Wheezing—(None) (Some) (Medium) (Severe)
      2. Coughing—(None) (Some) (Medium) (Severe)
      3. Shortness of Breath—(None) (Some) (Medium) (Severe)
      4. Tightness of Chest—(None) (Some) (Medium) (Severe)
      5. Missed Activities Due to Your Asthma—(Yes) (No)
   ii. Tap on Appropriate Triggers
      1. Weather Condition
      2. Dust
      3. Exercise
      4. Pollen
      5. Smoke
      6. Strong Odor
      7. Viral Illness
      8. Weather Condition
      9. Chemicals
      10. Allergies
   iii. Tap on ADLs (Activities Daily Living) Here is what I did today. Must comply with data collection for study and diagnostics for Pulmonology, Immunology and Allergist.
      1. Ate a good meal
      2. Dressed myself
      3. Did my homework
      4. Got in or out of a bed or chair
      5. Took a bath or shower
      6. Used the toilet
      7. Prepared my meals
      8. Managed my money
      9. Went shopping
      10. Did housework
      11. Used a telephone
      12. Exercise
         a. Duration
         b. Type
         c. Intensity
   iv. Tap On ODLs (Observation of Daily Living)
      1. Sleep patterns (Pattern 1) (Pattern 2) (Pattern n)
      2. Exercise behavior (Behavior 1) (Behavior 2) (Behavior n)
      3. Nutritional intake (0 to 999 cals) (1,000 to 2500 cals) (2,500+cals)
      4. Attitudes and Moods
      5. Alertness at work (Normal) (Sleepiness) (Needed Coffee)
      6. Alertness in class (Participated) (Teacher Boring) (Yawned a lot)
      7. Environmental
         a. Clutter in your room? (Yes) (No)
         b. Clutter in your working space? (Yes) (No)
      8. Take & Upload Photo
         a. Description
      9. Take & Upload Video
         a. Description
      10. Take & Upload Audio
         a. Description
   v. Type any other comments in text box
z. Review Asthma Action Plan based on the apps analysis of the above
   i. Do this . . .
   ii. Tap Button/Check Box for Acknowledgement/Adherence
aa. NO ACTION REQUIRED BY USER
   i. APDR Data is written by app to Personal Health Record (PHR) system.

### 4. Gamification, Incentivization & Motivation

a. Scoring and Point System for Each Action
i. 5—On-time
ii. 3—Performed
iii. 0—Not-performed
iv. −1—Missed dose
v. Symptom control bonuses
   1. Badges for 1 week
   2. Badge for 1 month

b. Scoreboard
i. Acknowledge Today's Air Condition
ii. Take Medication/Photo of Action
iii. Peak flow
iv. Diary Entry
v. Action Plan Action(s)

c. Redemption
i. Movie Tickets
ii. Apple iTunes Music

d. Instant reward mechanics

e. User feedback mechanics

### 5. Profile Configuration

a. List

b. Add

c. Modify

d. Remove

e. First Name

f. Last Name

g. Date of Birth

h. Height

i. Gender

j. Weight

k. Race or Ethnicity

l. Asthma Action Plan
i. Select Medication(s)
   1. Asthma Medication (Database)
      a. Brand Name
      b. Medical Name
      c. Thumbnail Photo
      d. Dose
      e. Frequency
      f. Number of doses in each refill—auto decrement
   g. Pharmacy
   h. Other Meds

m. Health History PHR
i. Enter/Review Required Elements
ii. Enter/Review Optional Elements

n. Help/Overview

### 6. View Diary

a. Share Diary

b. Today

c. This Week

d. Month

e. Year

f. Help/Overview

### 7. View Chart (Bars Instead of Line Graphs)

a. Share Chart

b. You Are Well

c. Getting Worse

d. Critical

e. Help/Overview

### 8. Personal Health Record

a. View

b. Modify Personal Information

c. Integrate with Patients Know Best PHR

d. Help

9. Asthma Action Plan (Prescribed by Medical Care Provider i.e. Doctor, Nurse, Respiratory Therapist. Practitioner will need an Online “Form” to fill in for each patients Plan.)

a. Your best peak flow reading

b. Important Information
i. Name
ii. Date
iii.
iv. Doctor Name
v. Phone Number
vi.
vii. Emergency Contact
viii. Emergency Phone
ix.

c. Exercise-Induced Flare-up
Instructions for an exercise-induced flare-up
   i. Medicine
   ii. How much
   iii. When
   iv. Additional Instructions (Multi-line Text)
   v.

d. Triggers (Yes/No)
i. Pollen
ii. Exercise
iii. Mold
iv. Cold/Flu
v. Dust Mites
vi. Weather
vii. Animals
viii. Air Pollution
ix. Smoke
x. Food
xi. Other (Text Field)

e. Green Zone—Doing Well
Also known as the safety zone
   i. Symptoms
      1. Breathing is easy
      2. No cough
      3. No wheezing
      4. No chest tightness
      5. No shortness of breath during the day or night
      6. Can do usual activities Peak
   ii. Flow Reading Greater Than (80%×Your Best)
   iii. Medication
      Use these controller medicines as listed:
         1. Medicine
         2. How much
         3. How often/when

f. Yellow Zone—Asthma is getting worse
Also known as caution zone
   i. Symptoms
      1. Some shortness of breath
      2. Cough, wheeze, or chest tightness
      3. Some difficulty doing usual activities
   4. Sleep disturbed by symptoms
      5. Symptoms of a cold or flu
   ii. Peak Flow Reading between (50% to 79%×Your Best)
   iii. Medication
      Continue with controller medicines as above, and add these rescue medicines:
         1. Medicine
         2. How much
         3. How Often/When
   iv. Call your doctor if: (Multi-line Text)

g. Red Zone—Medical Alert
Also known as the danger zone
   i. Symptoms
      1. Severe breathing problems
      2. Cannot do usual activities
      3. Difficulty walking and talking
      4. Rescue medicine is not helping
   ii. Peak Flow Reading Less Than (50%×Your Best)
   iii. Medication
      Take this medicine and call the doctor now!
         1. Medicine
         2. How much
         3. How often/when
   iv. If symptoms don't improve and you can't contact the doctor, go to the hospital or call 911.

h. Help/Overview

### 10. Contacts

a. Select From Device Contacts

b. First Name

c. Last Name

d. Type (Select from List)
i. Emergency
ii. Parent
iii. Coach
iv. Teacher
v. Doctor
vi. Add Custom

e. Email 1

f. Email 2

g. Best Number

h. Second Number

i. Help

### 11. Settings

a. Bluetooth Devices
i. Flow Meter Status
ii. Inhaler Status

b. Update Settings

c. Pharmacy Link Settings

d. PHR Settings
i. Patients Know Best
ii. Microsoft HealthVault

e. Alerts and Notifications Settings
i. Push Notifications
ii. SMS
iii. Email

f. Help/Overview

### 12. Care Team Permissions and Settings

a. Doctor #1
i. Name
ii. Contact
iii. Specialty

b. Doctor #2
i. Name
ii. Contact
iii. Specialty

c. Doctor n

d. School Health Worker

e. Case Worker

f. Parents/Guardians

g. Social Worker

h. Insurance/MCO

### 13. Healthcare Presentation and Reporting

a. Doctor #1
i. Name
ii. Contact
iii. Specialty

b. Symptoms by
i. Day
ii. Date
iii. Time
iv. Severity

c. ODL by
i. Day
ii. Date
iii. Time

d. Med compliance

e. Correlation of above

f. Raw data export facility for statistical analysis

Platform Integration and Data Requirements

Each system requirement below will require a documented API, set of web services/methods and appropriate secure access to cloud-based database structure and architecture by mobile devices.

### Air Now

a. Air Quality Index Forecasts By Zip Code
b. Air Quality Index Observed (Current Actual) By Zip Code

### Patients Know Best

c. Patient and Healthcare Provider User Authentication (oAuth)
d. Personal Health Record (PHR)
   a. Various Lookup Tables
e. Asthma Action Plan Data Entry Form integrated with PHR
   a. Various Lookup Tables
f. Asthma Personal Daily Record (APDR) integrated with PHR
   a. Various Lookup Tables
g. Symptom tracking with relevant actions
   a. Various Lookup Tables
h. Medication/Drug Lookup Table/Database integrated with PHR
i. Medication Tracking, Reminder and Triggers database with relevant actions for each drug and dose integrated with PHR
j. Pharmacy linkage (i.e. CVS, Walgreens, RiteAID) integrated with PHR
k. Raw Clinical Research Data presentation and tracking for statistical analysis (HL7 v2)

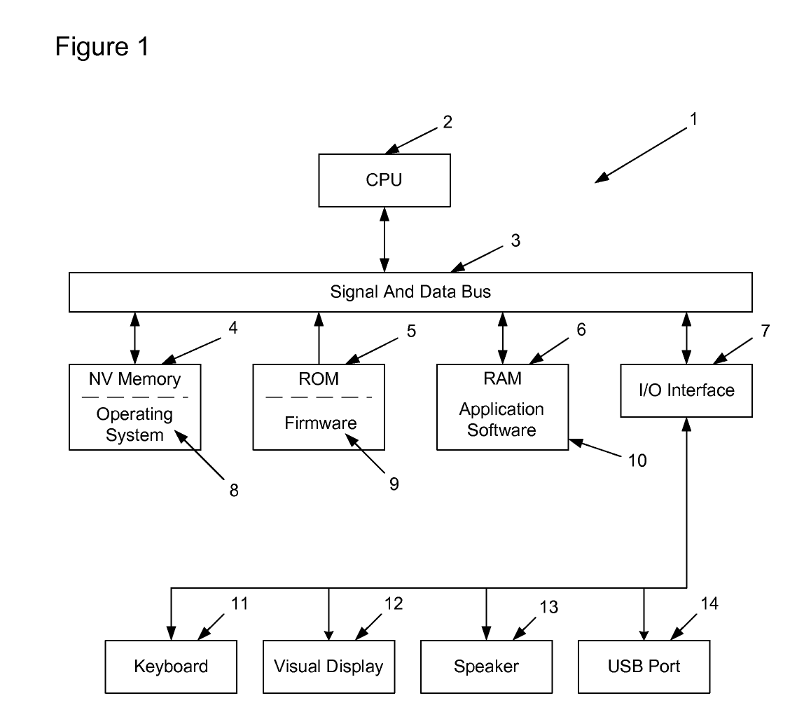

FIG. 1 is a block diagram that illustrates the basic components of a smartphone 1 on which the present invention may be practiced.

Smartphone 1 includes a CPU 2. The CPU is used for executing computer software instructions as is known in the art. CPU 2 is coupled to a number of other elements via a signal and data bus 3 as is also known in the art. These elements include ROM 5 (Read Only Memory) which may be used to store computer software instructions, RAM 6 (Random Access Memory) which also may be used to store computer software instructions, I/O Interface 7 which may be used to interface CPU 2 to elements and/or functions that are external to smartphone 1, and Non Volatile Memory 4 which may be used to store computer software instructions as well.

As mention above, I/O Interface 7 is used to interface CPU 2 to elements or functions that are external to smartphone 1. These external elements might include Keyboard 11, Visual Display 12, Speaker 13, and USB Port 14.

Depending on the tasks to be performed by smartphone 1, its computer software instructions might be divided into two or more separate and distinct categories which are stored in separate portions of ROM 5, RAM 6 and/or Non Volatile Memory 4. In some devices, a basis set of low level operating instructions, known in the art as firmware 9, might be stored in, for example, ROM 5. These low level rudimentary instructions provide the necessary instructions for how the smartphone communicates with the other computer hardware. Such instructions are necessary for the smartphone to perform any useful work, regardless of the application for which the device is to be used.

The computer instruction set that is executed by CPU 2 to perform the particular tasks required of the smartphone is often call “application software” and operationally “sits” on top of firmware 9. As illustrated in FIG. 1, application software 10 is stored in RAM 6. Application software 10 could also be stored in ROM 5 or in Non Volatile Memory 4.

Firmware 9 allows application software 10 to efficiently interface with the other device hardware, such as the elements that are coupled to CPU 2 via I/O Interface 3.

Again, depending on the tasks to be performed by smartphone 1, a third set of software instructions known in the art as an operating system 8 might operationally “sit” between firmware 9 and application software 10. Operating system 8 is shown as being stored in Non Volatile Memory 4 in FIG. 1 but could be store in RAM 6 as well.

Operating system 8 is the software that is responsible for the management and coordination of activities and the sharing of resources within smartphone 1.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. A method of managing a chronic disease suffered by a patient, said method comprising the steps of:
determining a management plan for said chronic disease;
providing a real time analysis module for analyzing and modifying said management plan in accordance with environmental factors;
determining a regiment of medications for managing said chronic disease in accordance with said management plan; and
generating a plurality of reminders for the patient to take said regiment of medications.
